(19) United States
(12) Patent Application Publication
(10) Pub. No.: US 2004/0155635 A1
(43) Pub. Date: Aug. 12, 2004

(54) Stabilized power supply-use device, and switching power supply and electronic device using the same

(76) Inventor: Katsumi Inaba, Tondabayashi-shi (JP)

Correspondence Address: EDWARDS & ANGELL, LLP, P.O. BOX 55874, BOSTON, MA, 02205, US

(21) Appl. No.: 10/742,081

(22) Filed: Dec. 18, 2003

(30) Foreign Application Priority Data
Feb. 6, 2003 (JP) 2003-030051

(51) Int. Cl. G05F 1/573

(52) U.S. Cl. 323/277

(57) ABSTRACT

A stabilized power supply-use device of the present invention, which is mounted on a switching power supply, is an IC into which power transistors, a control circuit for controlling a base current of the power transistors, and other electronic components are formed, and an overcurrent detecting resistor connected in series with the power transistor is realized by a resister provided externally to the IC. Therefore, as compared to the overcurrent detecting resistor being made up of aluminum wiring patterns inside the IC, the overcurrent detecting resistor of the present invention dramatically decreases variations in value of resistance, whereby it is possible to improve an accuracy of voltage detection and to arbitrarily set a value of resistance. This eliminates the need for a needlessly increased input power capacity in a test based on safety standard and other tests, thereby enabling a switching power supply manufactured at a lower cost.

### FIELD OF THE INVENTION

The present invention relates to a stabilized power supply-use device including power transistors, a control circuit of the power transistor, and other electronic components which are formed into an integrated circuit, and constituting a main part of the stabilized power supply, used for a power supply for VCR (Video Cassette Recorder) use, for example, in which an input voltage is stabilized to a desired voltage so as to be outputted by stepping down the input voltage through on-resistance of the power transistor or switching the power transistor, and relates to a switching power supply and an electronic device using the stabilized power supply-use device.

### BACKGROUND OF THE INVENTION

FIG. 9 is a block diagram showing an electrical arrangement of a typical switching power supply 1 used for a power supply for VCR use, and others. The switching power supply 1 is a so-called three-terminal regulator including an input terminal P1, an output terminal P2, and an earth terminal P3, and primarily includes: an integrated circuit (hereinafter referred to IC) 2 for performing switching operation; a smoothing capacitor C1 for stabilizing an input voltage Vin and outputting the input voltage Vin to the IC 2; a choke coil L1 for smoothing a current switched by the IC 2; a reflux diode D1 and a smoothing capacitor C2; voltage-dividing resistors R1 and R2 for dividing a smoothed output voltage Vo to feed back to the IC 2.

The IC 2 maintains the output voltage Vo constant by switching the input voltage Vin supplied to a first terminal of the IC 2, outputting it from a second terminal of the IC 2 to the choke coil L1 and the reflux diode D1, and changing the switching duty in accordance with a feedback voltage Oadj fed back from a fourth terminal of the IC 2. A third terminal of the IC 2 is connected to ground. A fifth terminal of the IC 2 is a terminal for detecting the rising edge of the input voltage Vin and is used for a soft start control as will hereinafter be described.

FIG. 10 is a block diagram showing an electrical arrangement of a typical and conventional IC 11 used for the IC 2. In FIG. 10, components corresponding to those in FIG. 9 are given the same reference numerals. The IC 11 includes power transistors q1 and q2, a reference voltage source (VREF) 12, an error (differential) amplifier 13, an oscillator 14, a PWM (Pulse Width Modulation) comparator 15, an NOR gate 16, an overcurrent detecting resistor r11, an overcurrent detection circuit 17, an overheat detection circuit 18, an OR gate 19, a flip-flop 20, a constant voltage circuit 21, an ON/OFF circuit 22, a soft start circuit 23, a zener diode d11, and a resistor r12.

The error amplifier 13 amplifies the difference between the feedback voltage Oadj from a fourth terminal of the IC 11 and an internal reference voltage VREF generated in the reference voltage source 12. The PWM comparator 15 slices a triangular wave from the oscillator 14 to generate a control switching pulse in accordance with an output voltage of the error amplifier 13. The control switching pulse is supplied via the NOR gate 16 to a base of the P-type power transistor q2 so that switching is performed in the power transistors q1 and q2.

The power transistor q2 and the N-type power transistor q1 which is connected in series with an output line are in Darlington connection. A low level input from the NOR gate 16 to the base of the power transistor q2 results in the power transistor q2 being on. This also causes the power transistor q1 to be on, and a switching pulse is outputted from a second terminal of the IC 11. The outputted switching pulse is supplied to a load while exciting the choke coil L1 shown in FIG. 9. On the other hand, a high level input to the base of the power transistor q2 results in the power transistor q2 being off. This also causes the power transistor q1 to be off, and the switching pulse is not outputted from the second terminal of the IC 11. Energy stored in the choke coil L1 is released via the reflux diode D1. Then, the switching duty is changed in accordance with the feedback voltage Oadj, thereby performing constant voltage control to maintain the output voltage Vo constant.

Meanwhile the flip-flop 20 is reset at each oscillation cycle by a pulse from the oscillator 14. However, the flip-flop 20 is not set while an abnormal output is not fed from the OR gate 19, i.e. both the overcurrent detection circuit 17 and the overheat detection circuit 18, an output Q-bar (Q-bar represents the inverted output) goes high level. The NOR gate 16 inverts the switching pulse fed from the PWM comparator 15 and supplies the inverted switching pulse to the base of the power transistor q2. On the other hand, when an abnormal output is fed from either the overcurrent detection circuit 17 or the overheat detection circuit 18, the flip-flop 20 is set, and the output Q-bar goes low level. The NOR gate 16 masks the switching pulse from the PWM comparator 15, which stops switching of the power transistors q2 and q1.

At the next switching cycle, the flip-flop 20 is reset by a pulse from the oscillator 14. However, if the abnormal output from the overcurrent detection circuit 17 or the overheat detection circuit 18 is fed continuously, the switching pulse is kept masked. If the abnormal output is removed, the switching becomes possible. In this manner, overcurrent protection and overheat protection are carried out.

The overcurrent detecting resistor r11, which is inserted between a first terminal of the IC 11 and a collector of the power transistor q1, is made up of aluminum wiring patterns inside the IC 11. The overcurrent detection circuit 17 detects the occurrence of an overcurrent on the basis of whether a voltage drop across the overcurrent detecting resistor r11 is of a predetermined voltage level.

The constant voltage circuit 21 supplies a power based on the input voltage Vin to internal circuits of the IC 11, such as the error amplifier 13 and the PWM comparator 15. The ON/OFF circuit 22 is connected to a fifth terminal of the IC 11 via the resistor r12. When the fifth terminal goes low level, i.e. a supply of the input voltage Vin is cut off, the ON/OFF circuit 22 causes the power transistors q2 and q1 to be off. When the fifth terminal goes high level, i.e. the input voltage Vin rises, the ON/OFF circuit 22 causes the power transistors q2 and q1 to be on.

With an arrangement in which a capacitor is additionally connected to a zeroth terminal connected to the first terminal, to which the input voltage Vin is supplied, so as to prevent overshoot of the output voltage Vo, the soft start circuit 23 prevents overshoot of the output voltage Vo by comparing an output voltage from the error amplifier 13 with a voltage of the connected capacitor increased by a constant current outputted from the zeroth terminal at power-on and by gradually expanding a pulse width for being the power transistors q2 and q1 on. The zener diode d11 is inserted to clamp an upper limit voltage of the capacitor when the capacitor is additionally connected to the zeroth terminal.

The above-arranged IC 11 aims for integration of electronic components as an IC in Japanese Laid-Open Patent application No. 180806/1994 (Tokukaihei 6-180806; published on Jun. 28, 1994), and integrates essential components making up a switching power supply, such as the power transistor q2 and q1 and circuits for controlling the power transistor q2 and q1. However, some switching power supplies include the IC 2 being made up of discreet components. In such a switching power supply, an overcurrent detection capability is generally not included in the IC 2.

The conventional IC 11 as described above is susceptible to variations in the overcurrent detecting resistor r11 being made up of aluminum wiring patterns. At an overload test based on a safety standard for a power supply of a product, the conventional IC 11 is beyond a safety standard for the product, for example, 15W, as indicated by reference numerals α1-α2 in FIG. 11. When it is beyond 15W, another test is required, and it takes a lot of trouble with a test based on a safety standard. In addition, an input power capacity must be set to be large enough so that the switching power supply does not go down even at the upper limit power of a safety standard up to a power in an overloaded state.

### SUMMARY OF THE INVENTION

An object of the present invention is to provide a stabilized power supply-use device which can simplify a test procedure and eliminate the need for a needlessly increased input power capacity, and a switching power supply and an electronic device using the stabilized power supply-use device.

In order to achieve the above object, a stabilized power supply-use device of the present invention includes: an integrated circuit for use in stabilizing an input voltage to a predetermined voltage so as to output the predetermined voltage; and an element for overcurrent detection being exposed outside of the integrated circuit.

According to the above arrangement, a stabilized power supply-use device formed as an integrated circuit integrally includes power transistors, a control circuit for controlling a base current and a gate voltage of the power transistor, and other electronic components, wherein an element for overcurrent detection, which was conventionally included in the integrated circuit, is exposed outside of the integrated circuit by being connected in series with the power transistor.

Therefore, as compared to the element for overcurrent detection being made up of aluminum wiring patterns, the element for overcurrent detection of the present invention dramatically decreases element variations, whereby it is possible to improve an accuracy of voltage detection and to arbitrarily set a constant for an element. This can simplify a test procedure and eliminate the need for a needlessly increased input power capacity in a test based on safety standard and other tests, thereby enabling a switching power supply manufactured at a lower cost.

Further, another stabilized power supply-use device of the present invention includes: an integrated circuit for use in stabilizing an input voltage to a predetermined voltage so as to output the predetermined voltage by controlling a power transistor which is connected in series with a power supply line; and an overcurrent detecting resistor which is connected in series with the power supply line being realized by a resistor externally provided to the integrated circuit.

According to the above arrangement, a stabilized power supply-use device of the present invention, which is a semiconductor device for use in a stabilized power supply, includes a power transistor and an overcurrent detecting resistor, wherein the power transistor is connected in series with a power supply line, on-resistance of the power transistor being changed, or the power transistor being switched so that an input voltage is stabilized to a predetermined voltage so as to be outputted, and the semiconductor device being formed as an integrated circuit in which the power transistor is integrally included with a control circuit for controlling the power transistor and other electronic components in order to obtain the predetermined voltage, wherein the overcurrent detecting resistor, which was conventionally included in the integrated circuit, is provided externally.

Therefore, as compared to the overcurrent detecting resistor being made up of aluminum wiring patterns inside the integrated circuit, the overcurrent detecting resistor of the present invention dramatically decreases variations in value of resistance, whereby it is possible to improve an accuracy of voltage detection and to arbitrarily set a value of resistance. This eliminates the need for a needlessly increased input power capacity in a test based on safety standard and other tests, thereby enabling a switching power supply manufactured at a lower cost.

A switching power supply of the present invention uses the above-described stabilized power supply-use device.

According to the above arrangement, it is possible to realize a low-cost switching power supply eliminating the need for a needlessly increased input power capacity in a test based on safety standard and other tests.

Still further, an electronic device of the present invention uses the above-described switching power supply.

According to the above arrangement, for the power supply for VCR use and other power supply, it is possible to mount a low-cost power supply eliminating the need for a needlessly increased input power capacity in a test based on safety standard and other tests.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a block diagram showing an electrical arrangement of an IC according to the first embodiment of the present invention for use in a switching power supply.

FIG. 2 is a front view showing an example of a specific configuration of the IC shown in FIG. 1.

FIG. 3 is a block diagram showing an electrical arrangement of an IC according to the second embodiment of the present invention.

FIG. 4 is a block diagram showing an electrical arrangement of an IC according to the third embodiment of the present invention.

FIG. 5 is a block diagram showing an electrical arrangement of an IC according to the fourth embodiment of the present invention.

FIG. 6 is a block diagram showing an alternative electrical arrangement of the IC according to the fourth embodiment of the present invention.

FIG. 7 is a block diagram showing an electrical arrangement of an IC according to the fifth embodiment of the present invention.

FIG. 8 is a block diagram showing an electrical arrangement of an IC according to the sixth embodiment of the present invention.

FIG. 9 is a block diagram showing an electrical arrangement of a typical switching power supply used for a power supply for VCR use.

FIG. 10 is a block diagram showing an electrical arrangement of a typical and conventional IC for use in the switching power supply.

FIG. 11 is a graph showing current-voltage characteristics of a switching power supply caused by variations in overcurrent detecting resistors in the conventional art and the present invention.

### DESCRIPTION OF THE EMBODIMENTS

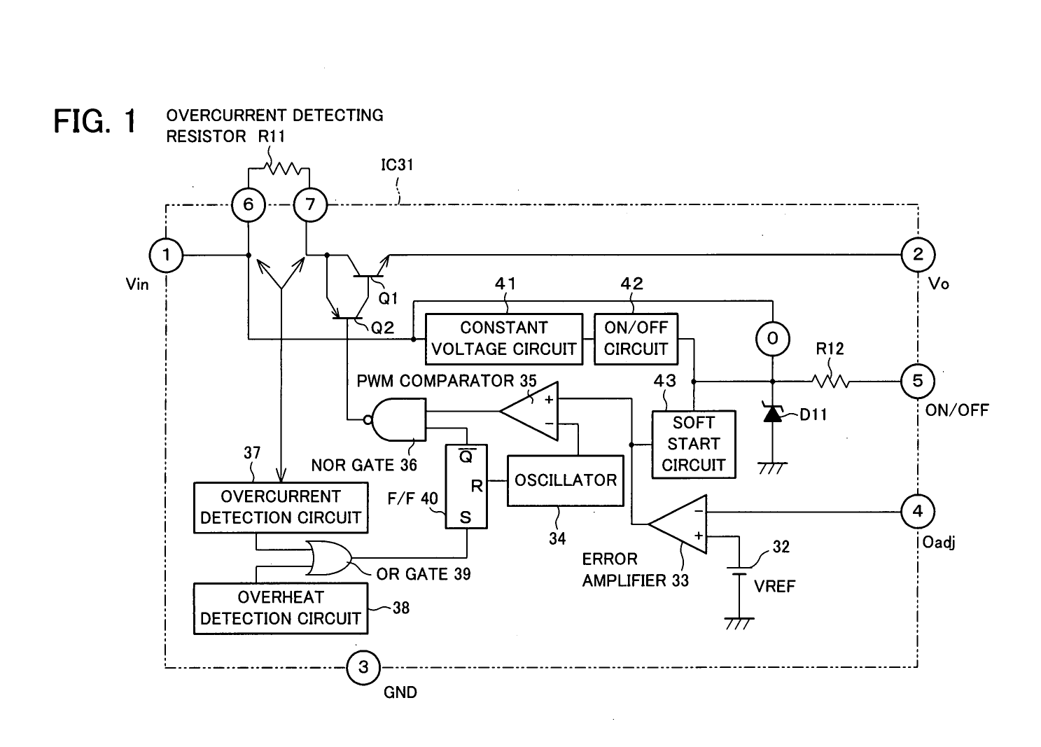

The following will describe embodiments of the present invention with reference to FIG. 1 through FIG. 8 and FIG. 11.

### First Embodiment

The following will describe the first embodiment of the present invention with reference to FIGS. 1, 2, and 11.

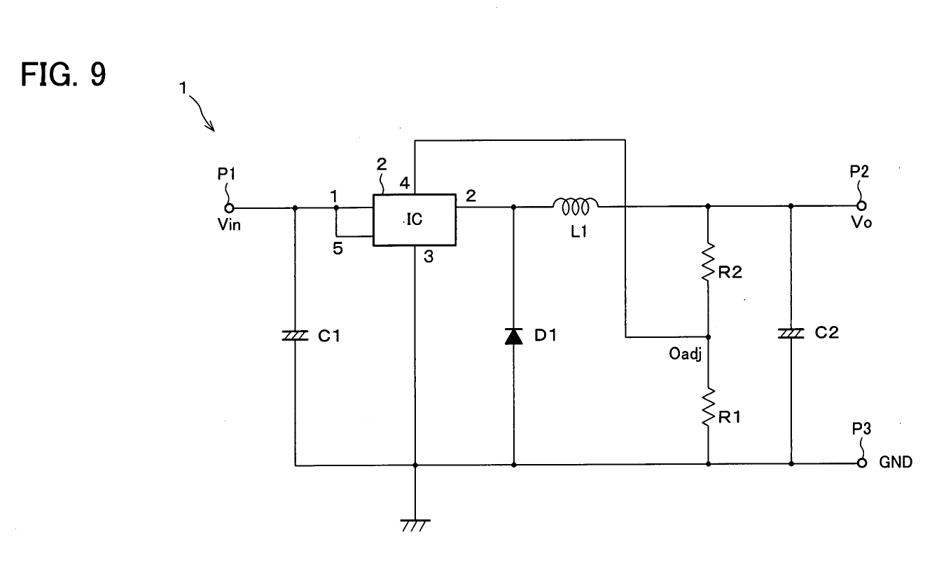

FIG. 1 is a block diagram showing an electrical arrangement of an IC 31 of the first embodiment of the present invention. The IC 31 is used for the IC 2 in the switching power supply 1 shown in FIG. 9, and in FIG. 1, components corresponding to those in FIG. 9 are given the same reference numerals. The IC 31 includes power transistors Q1 and Q2, a reference voltage source 32, an error amplifier 33, an oscillator 34, a PWM comparator 35, an NOR gate 36, an overcurrent detecting resistor R11, an overcurrent detection circuit 37, an overheat detection circuit 38, an OR gate 39, a flip-flop 40, a constant voltage circuit 41, an ON/OFF circuit 42, a soft start circuit 43, a zener diode D11, and a resistor R12.

The error amplifier 33 amplifies a difference between the feedback voltage Oadj to a fourth terminal of the IC 31 and an internal reference voltage VREF generated in the reference voltage source 32. The PWM comparator 35 slices a triangular wave from the oscillator 34 to generate a control switching pulse in accordance with an output voltage of the error amplifier 33. The control switching pulse is supplied via the NOR gate 36 to a base of the P-type power transistor Q2 so that switching is performed in the power transistors Q1 and Q2.

The power transistor Q2 and the N-type power transistor Q1 which is connected in series with an output line are in Darlington connection. A low level input from the NOR gate 36 to the base of the power transistor Q2 results in the power transistor Q2 being on. This also causes the power transistor Q1 to be on, and a switching pulse is outputted from a second terminal of the IC 31. The switching pulse is supplied to a load while exciting the choke coil L1. On the other hand, a high level input to the base of the power transistor Q2 results in the power transistor Q2 being off. This also causes the power transistor Q1 to be off, and the switching pulse is not outputted from the second terminal of the IC 31. Energy stored in the choke coil L1 is released via the reflux diode D1. Then, the switching duty is changed in accordance with the feedback voltage Oadj, thereby performing constant voltage control to maintain the output voltage Vo constant.

Meanwhile the flip-flop 40 is reset at each oscillation cycle by a pulse from the oscillator 34. The flip-flop 40 is not set while an abnormal output is not fed from the OR gate 39, i.e. both the overcurrent detection circuit 37 and the overheat detection circuit 38, an output Q-bar from the flip-flop 40 goes high level voltage. At this moment, the NOR gate 36 where the high level voltage is inputted to one end thereof inverts the switching pulse fed from the PWM comparator 35 and supplies the inverted switching pulse to the base of the power transistor Q2.

On the other hand, when an abnormal output is fed from either the overcurrent detection circuit 37 or the overheat detection circuit 38, the flip-flop 40 is set, and the output Q-bar goes low level. The NOR gate 36 where a voltage of low level is inputted to one end thereof masks the switching pulse from the PWM comparator 35, which stops switching of the power transistors Q2 and Q1.

At the next switching cycle, the flip-flop 40 is reset by a pulse from the oscillator 34. However, if the abnormal output from the overcurrent detection circuit 37 or the overheat detection circuit 38 is fed continuously, the switching pulse is kept masked. If the abnormal output is removed, the switching becomes possible. In this manner, overcurrent protection and overheat protection are carried out.

The constant voltage circuit 41 supplies a power based on the input voltage Vin to internal circuits of the IC 31, such as the error amplifier 33 and the PWM comparator 35. The ON/OFF circuit 42 is connected to a fifth terminal of the IC 31 via the resistor R12. When the fifth terminal goes low level, i.e. a supply of the input voltage Vin is cut off, the ON/OFF circuit 42 causes the power transistors Q2 and Q1 to turn off. When the fifth terminal goes into high level, i.e. the input voltage Vin rises, the ON/OFF circuit 42 causes the power transistors Q2 and Q1 to turn on.

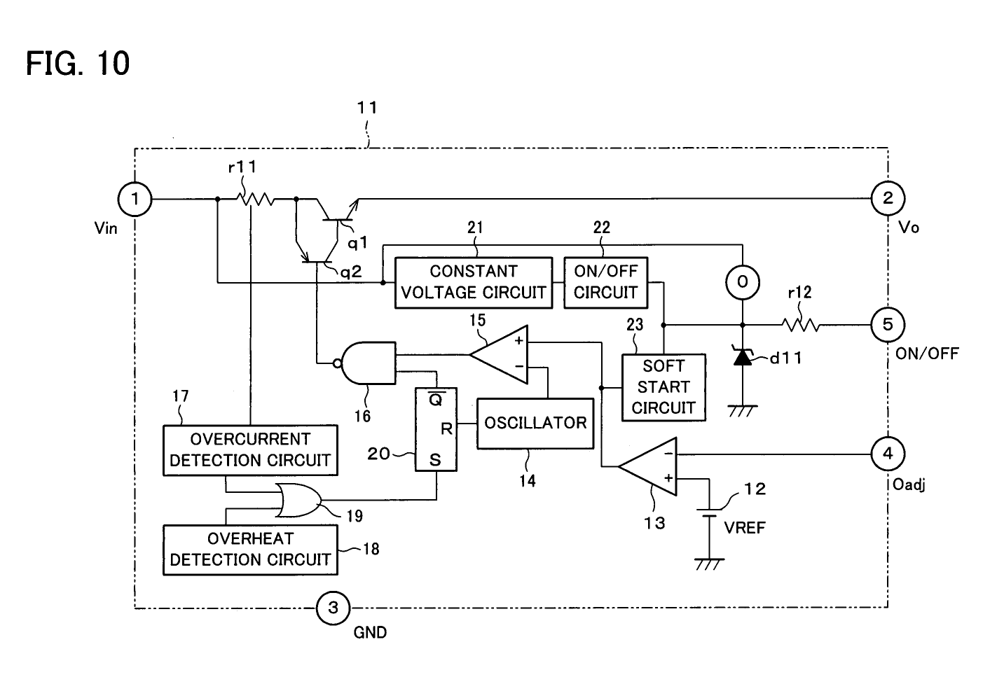

With an arrangement in which a capacitor is additionally connected to a zeroth terminal connected to the first terminal, to which the input voltage Vin is supplied, so as to prevent overshoot of the output voltage Vo, the soft start circuit 43 prevents overshoot of the output voltage Vo by comparing an output voltage from the error amplifier 33 with a voltage of the connected capacitor increased by a constant current outputted from the zeroth terminal at power-on and by gradually expanding a pulse width for being the power transistors Q2 and Q1 on. The zener diode D11 is inserted to clamp an upper limit voltage of the capacitor when the capacitor is additionally connected to the zeroth terminal. The above arrangement of the IC 31 is the same as the arrangement of the conventional IC 11 shown in FIG. 10.

Note that, in the IC 31 of the present invention, the overcurrent detecting resistor R11 is inserted externally between a sixth terminal connected to the first terminal to which the input voltage Vin is supplied and a seventh terminal connected to a collector of the power transistor Q1. The overcurrent detection circuit 37 receives voltages from the sixth and seventh terminals and detects the occurrence of an overcurrent on the basis of whether a voltage drop across the overcurrent detecting resistor R11 is of a predetermined voltage level.

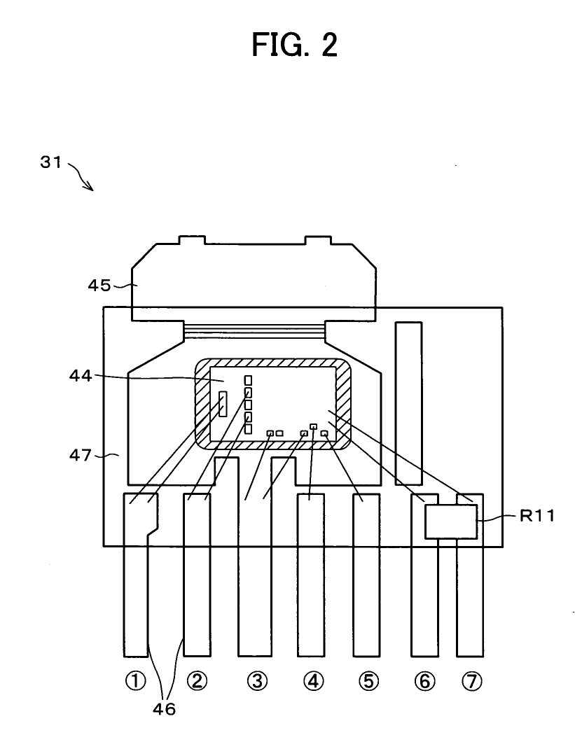

FIG. 2 is a front view showing an example of a specific configuration of the above-arranged IC 31. An IC chip 44 arranged as shown in FIG. 1 is fixed on the lead frame 45 by die bonding, and then is interconnected by wire bonding to lead terminals 46 corresponding to the first through seventh terminals respectively indicated by reference numerals (1) through (7). Thereafter, the overcurrent detecting resistor R11 consisting of chip components is mounted between lead terminals respectively corresponding to the sixth and seventh terminals, and then sealed hermetically by a mold resin 47.

As compared to the overcurrent detecting resistor r11 being made up of aluminum wiring patterns, the overcurrent detecting resistor R11 being made up of chip components dramatically decreases element variations, whereby it is possible to improve an accuracy of voltage detection and to arbitrarily set a constant for a element. This can simplify a test procedure and eliminate the need for a needlessly increased input power capacity in a test based on safety standard and other tests, thereby enabling a switching power supply manufactured at a lower cost.

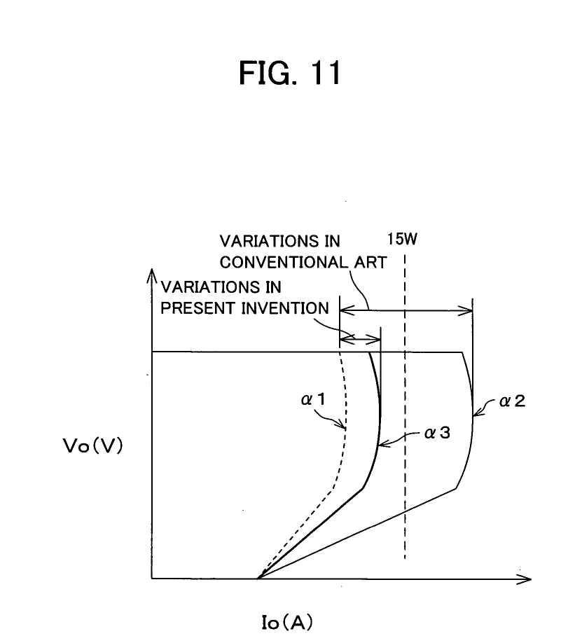

In FIG. 11, current-voltage characteristic caused by the variations in the present invention is indicated by reference numeral α3. The variations in the present invention are surely reduced within 15W, which is a power rating of the switching power supply. Therefore, another test is not required in the current-voltage characteristic test, and it is possible simplify a test procedure as described above.

### Second Embodiment

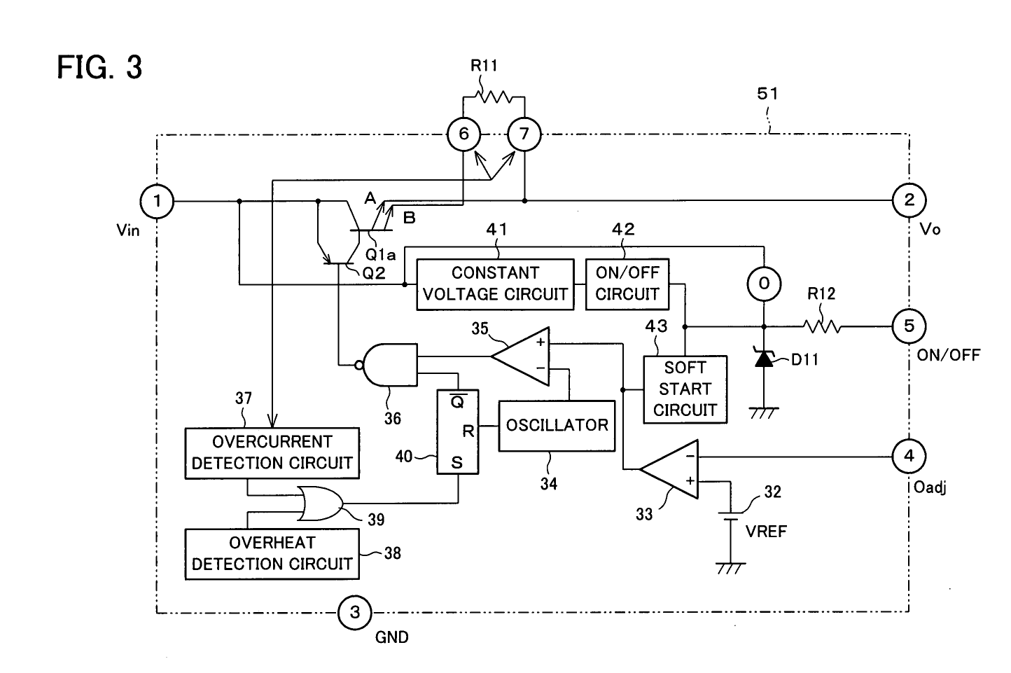

The following will describe the second embodiment of the present invention with reference to FIG. 3.

FIG. 3 is a block diagram showing an electrical arrangement of an IC 51 of the second embodiment of the present invention. The IC 51 is similar to the above-described IC 31. Components corresponding to those in the IC 31 are given the same reference numerals, and explanations thereof are omitted.

Note that, in the IC 51, a P-type power transistor Q1a inserted in series with a power supply line is provided with multi-emitter outputs. The overcurrent detecting resistor R11 is provided on the emitter side of the power transistor Q1a, and a terminal A on a large-current output of the power transistor Q1a is directly connected to a second terminal of the IC 51, which is an output terminal. A terminal B on a small-current (e.g. as small as 1/1000 of the current carried on the terminal A of the large-current output) output of the power transistor Q1a is connected to one terminal of the overcurrent detecting resistor R11 via a sixth terminal, and a seventh terminal which is connected to the other terminal of the overcurrent detecting resistor R11 is connected to the second terminal, which is an output terminal.

Therefore, different from the power transistor Q1 outputting a full-load current to the overcurrent detecting resistor R11, the power transistor Q1a divides the full-load current into a small current and a large current. The small current is taken outside of the IC 51 so as to be outputted to the overcurrent detecting resistor R11, so that it is possible to reduce power consumed by the overcurrent detecting resistor R11.

### Third Embodiment

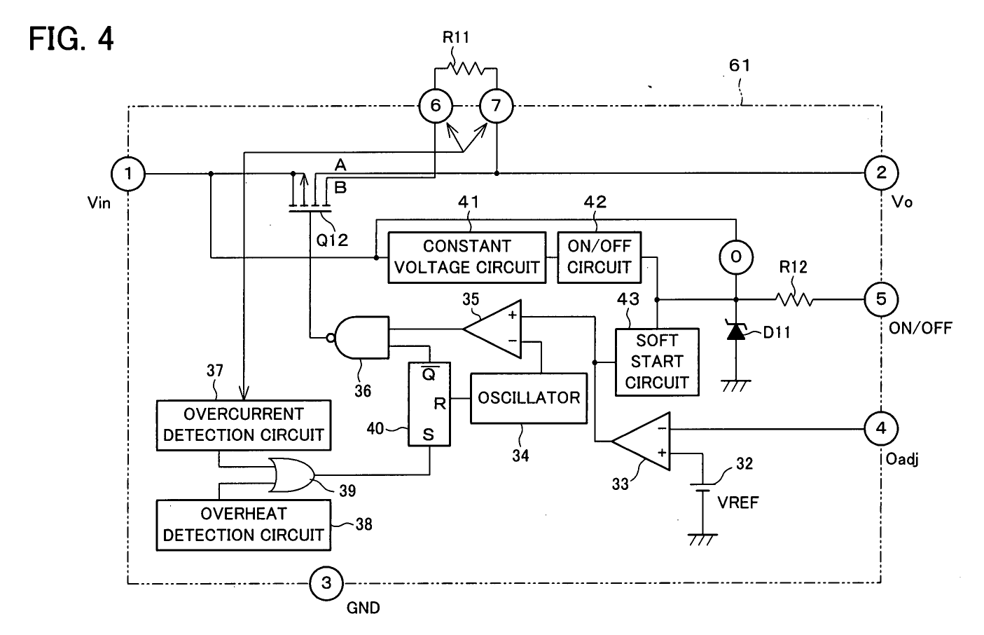

The following will describe the third embodiment of the present invention with reference to FIG. 4.

FIG. 4 is a block diagram showing an electrical arrangement of an IC 61 of the third embodiment of the present invention. The IC 61 is similar to the above-described IC 51. Components corresponding to those in the IC 51 are given the same reference numerals, and explanations thereof are omitted. Note that, the IC 61 replaces the power transistors Q1 and Q2 with a power MOSFET (Metal Oxide Semiconductor Field Effect Transistor) Q12 with a current-sense capability. A sense terminal B of the power MOSFET Q12 is connected to one terminal of the overcurrent detecting resistor R11 via a sixth terminal, and a seventh terminal which is connected to the other terminal of the overcurrent detecting resistor R11 is connected to a second terminals, which is an output terminal. A low active switching pulse from the NOR gate 36 is supplied to the gate of the P-type power MOSFET Q12.

Therefore, as the power transistor Q1a, the power MOSFET Q12 does not output a full-load current to the overcurrent detecting resistor R11, but outputs a minute current proportional to a load current carried on the sense terminal B to the overcurrent detecting resistor R11, so that it is possible to reduce power consumed by the overcurrent detecting resistor R11.

### Fourth Embodiment

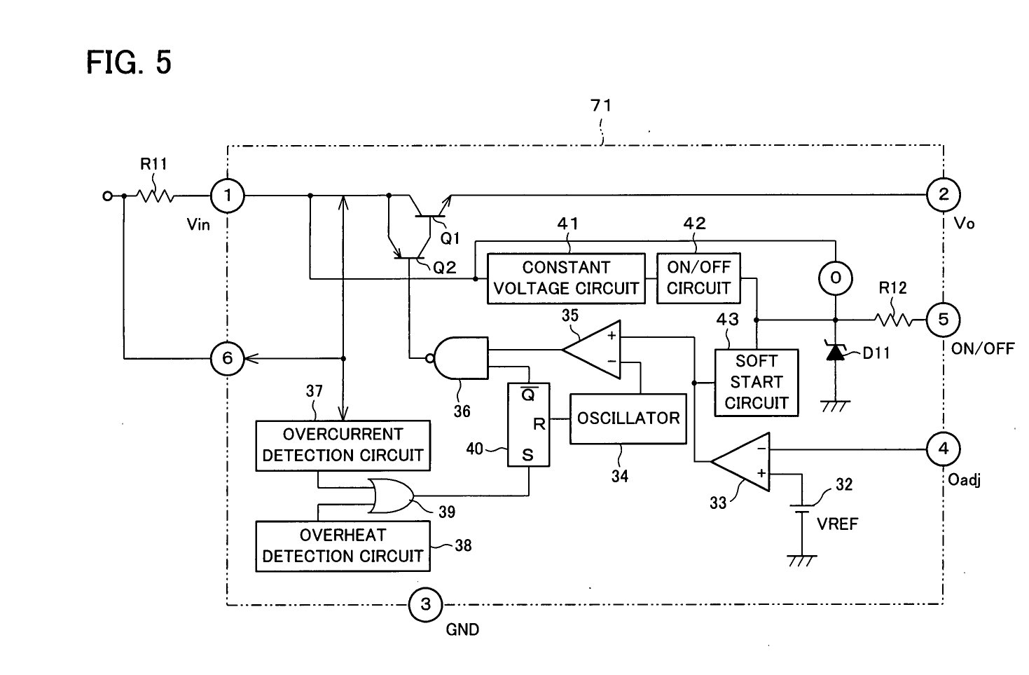

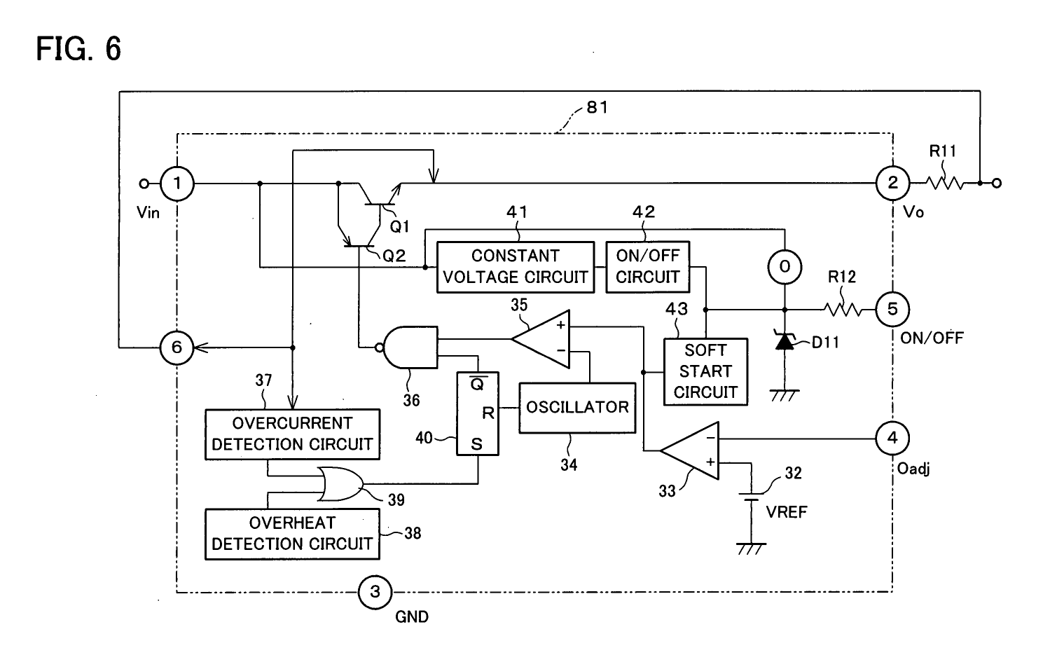

The following will describe the fourth embodiment of the present invention with reference to FIGS. 5 and 6.

FIG. 5 is a block diagram showing an electrical arrangement of an IC 71 of the fourth embodiment of the present invention. FIG. 6 is a block diagram showing an electrical arrangement of an IC 81 which is an alternative example of the fourth embodiment of the present invention. The ICs 71 and 81 are similar to the above-described IC 31. Components corresponding to those in the IC 31 are given the same reference numerals, and explanations thereof are omitted.

Note that, in the ICs 71 and 81, a lead terminal is used both as one of a pair of lead terminals, which are necessary to provide the overcurrent detecting resistor R11 externally as described above, and an input or output terminal.

That is, in the IC 71 shown in FIG. 5, one terminal of the overcurrent detecting resistor R11 is connected to a first terminal, which is an input terminal, and the other terminal is connected to a sixth terminal which is an input terminal of the input voltage Vin. Therefore, the seventh terminal connected to the collector of the power transistor Q1 in the IC 31 of FIG. 1 is omitted in the IC 71.

Meanwhile, in the IC 81 shown in FIG. 6, the overcurrent detecting resistor R11 is inserted on an emitter side of the power transistor Q1. One terminal of the overcurrent detecting resistor R11 is connected to a second terminal, which is an output terminal, and the other terminal is a sixth terminal, which is an output terminal of the output voltage Vo. Therefore, the seventh terminal in the IC 31 of FIG. 1 is omitted in the IC 81. In this manner, the number of lead terminals can be decreased.

### Fifth Embodiment

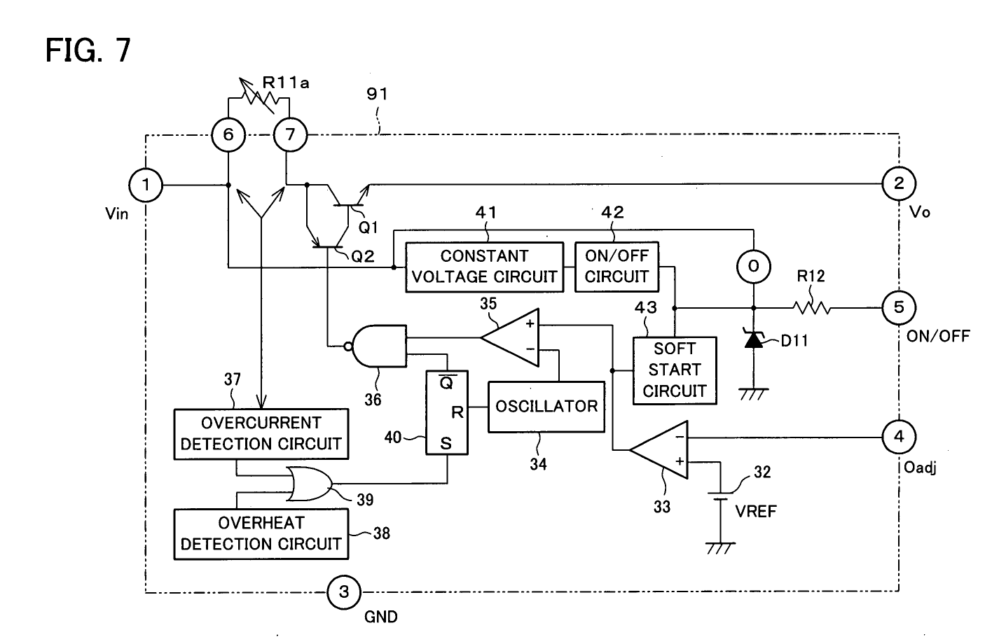

The following will describe the fifth embodiment of the present invention with reference to FIG. 7.

FIG. 7 is a block diagram showing an electrical arrangement of an IC 91 of the fifth embodiment of the present invention. The IC 91 is similar to the above-described IC 31. Components corresponding to those in the IC 31 are given the same reference numerals, and explanations thereof are omitted. Note that, in the IC 91, on the basis of the fact that the overcurrent detecting resistor is provided externally and exposed outside of the IC 91, an overcurrent detecting resistor R11a is realized by a variable resistor such as a semi-fixed resistor.

Therefore, a resistance value can be adjusted readily.

### Sixth Embodiment

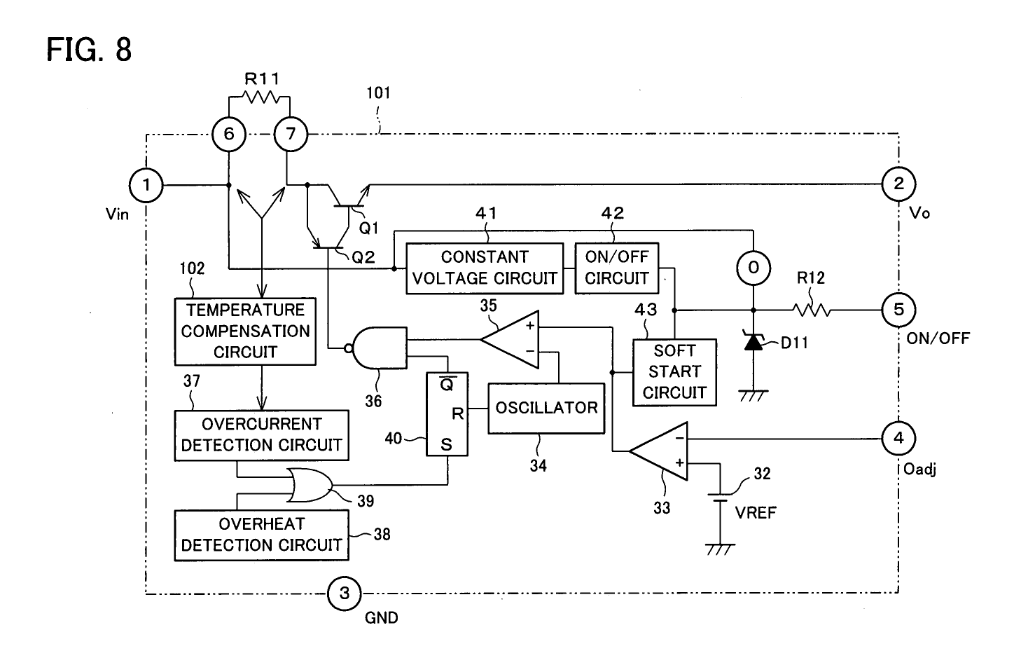

The following will describe the sixth embodiment of the present invention with reference to FIG. 8. FIG. 8 is a block diagram showing an electrical arrangement of an IC 101 of the sixth embodiment of the present invention. The IC 101 is similar to the above-described IC 31.

Note that, the IC 101 includes a temperature compensation circuit 102 having a temperature characteristic approximately equal to that of the overcurrent detecting resistor R11 which is provided externally. A result of the detection by the overcurrent detecting resistor R11 is compensated by the temperature compensation circuit 102 and inputted to the overcurrent detection circuit 37.

Therefore, change in resistance value of the overcurrent detecting resistor R11 with a temperature change is compensated by the temperature compensation circuit 102 inside the IC 101, so that it is possible to maintain a constant accuracy of current detection against temperature changes and to further suppress the above-described increase in the input power capacity.

Further, it is obvious that the sixth embodiment is applicable to all of the second through fifth embodiments.

The above description is given based on a switching power supply which causes the power transistor Q1, Q1a, or Q12 to switch so that the input voltage Vin is stabilized to the desired output voltage Vo so as to be outputted. The invention is also applicable to a step-down power supply in which the power transistor Q1, Q1a, or Q12 is connected in series with a power supply line, and on-resistance of the power transistor Q1, Q1a, or Q12 is caused to change.

As described above, a stabilized power supply-use device of the present invention formed as an integrated circuit integrally includes power transistors, a control circuit for controlling a base current and a gate voltage of the power transistor, and other electronic components, and an element for overcurrent detection, which was conventionally included in the integrated circuit, is exposed outside of the integrated circuit by being connected in series with the power transistor.

Therefore, as compared to the element for overcurrent detection being made up of aluminum wiring patterns, the element for overcurrent detection of the present invention dramatically decreases element variations, whereby it is possible to improve an accuracy of voltage detection and to arbitrarily set a constant for an element. This can simplify a test procedure and eliminate the need for a needlessly increased input power capacity in a test based on safety standard and other tests, thereby enabling a switching power supply manufactured at a lower cost.

Further, as described above, a stabilized power supply-use device of the present invention, which is a semiconductor device for use in a stabilized power supply, may comprise a power transistor and an overcurrent detecting resistor, wherein the power transistor is a power transistor and is connected in series with a power supply line, on-resistance of the power transistor being changed, or the power transistor being switched so that an input voltage is stabilized to a predetermined voltage so as to be outputted, and the semiconductor device being formed as an integrated circuit in which the power transistor is integrally included with a control circuit for controlling the power transistor and other electronic components in order to obtain the predetermined voltage wherein the overcurrent detecting resistor, which was conventionally included in the integrated circuit, is provided externally.

Therefore, as compared to the overcurrent detecting resistor being made up of aluminum wiring patterns inside the integrated circuit, the overcurrent detecting resistor of the present invention dramatically decreases variations in value of resistance, whereby it is possible to improve an accuracy of voltage detection and to arbitrarily set a value of resistance. This eliminates the need for a needlessly increased input power capacity in a test based on safety standard and other tests, thereby enabling a switching power supply manufactured at a lower cost.

Still further, as described above, a stabilized power supply-use device of the present invention may include a power transistor with multi-emitter, as the power transistor, which does not output a full-load current to the overcurrent detecting resistor, but divides the full-load current into a small current and a large current, and takes the small current outside and outputs it to the overcurrent detecting resistor.

Therefore, it is possible to reduce power consumed by the overcurrent detecting resistor.

Further, as described above, a stabilized power supply-use device of the present invention may include a power MOSFET with a current-sense capability as the power transistor which does not output a full-load current to the overcurrent detecting resistor, but takes outside a minute current proportional to a load current carried on the sense terminal so as to output it to the overcurrent detecting resistor.

Therefore, it is possible to reduce power consumed by the overcurrent detecting resistor.

Still further, as described above, a stabilized power supply-use device of the present invention may include a lead terminal used both as one terminal of the overcurrent detecting resistor and an input or output terminal. Therefore, the number of lead terminals can be decreased.

Further, as described above, a stabilized power supply-use device of the present invention may include an overcurrent detecting resistor realized by a variable resistor on the basis of the fact that the overcurrent detecting resistor is provided externally and exposed outside of the integrated circuit. Therefore, a resistance value can be adjusted readily.

Still further, as described above, a stabilized power supply-use device of the present invention may include a temperature compensation circuit having a temperature characteristic approximately equal to that of the overcurrent detecting resistor externally provided in the integrated circuit.

Therefore, change in resistance value of the overcurrent detecting resistor, which provided externally and exposed outside of the integrated circuit, with a temperature change is compensated by the temperature compensation circuit in a control circuit inside the integrated circuit, so that it is possible to maintain a constant accuracy of current detection and to further suppress the above-described increase in the input power capacity.

Further, as described above, a switching power supply of the present invention includes the above-described stabilized power supply-use device.

Therefore, it is possible to realize a low-cost switching power supply eliminating the need for a needlessly increased input power capacity in a test based on safety standard and other tests.

Still further, as described above, an electronic device of the present invention includes the above-described switching power supply.

Therefore, for the power supply for VCR use and other power supply, it is possible to mount a low-cost power supply eliminating the need for a needlessly increased input power capacity in a test based on safety standard and other tests.

The invention being thus described, it will be obvious that the same may be varied in many ways. Such variations are not to be regarded as a departure from the spirit and scope of the invention, and all such modifications as would be obvious to one skilled in the art intended to be included within the scope of the following claims.

What is claimed is:

1. A stabilized power supply-use device, comprising:
an integrated circuit for use in stabilizing an input voltage to a predetermined voltage so as to output the predetermined voltage; and
an element for overcurrent detection being provided to be exposed outside of the integrated circuit.

2. A stabilized power supply-use device, comprising:
an integrated circuit for use in stabilizing an input voltage to a predetermined voltage so as to output the predetermined voltage by controlling a power transistor which is connected in series with a power supply line; and
an overcurrent detecting resistor which is connected in series with the power supply line being realized by a resistor externally provided to the integrated circuit.

3. The stabilized power supply-use device according to claim 2, wherein:
the power transistor is a transistor with multi-emitter outputs, and the overcurrent detecting resistor is connected to a small-current output of the multi-emitter outputs.

4. The stabilized power supply-use device according to claim 2, wherein:
the power transistor is realized by a power MOSFET with current-sense capability, and the overcurrent detecting resistor is connected to a sense terminal of the power MOSFET.

5. The stabilized power supply-use device according to claim 2, wherein:
a lead terminal is used both as one terminal of the overcurrent detecting resistor and an input or output terminal.

6. The stabilized power supply-use device according to claim 2, wherein:
the overcurrent detecting resistor is a variable resistor.

7. The stabilized power supply-use device according to claim 2, wherein:
the integrated circuit includes a temperature compensation circuit having a temperature characteristic approximately equal to that of the overcurrent detecting resistor externally provided.

8. A switching power supply including a stabilized power supply-use device which comprises: an integrated circuit for use in stabilizing an input voltage to a predetermined voltage so as to output the predetermined voltage; and an element for overcurrent detection being provided to be exposed outside of the integrated circuit.

9. A switching power supply including a stabilized power supply-use device which comprises: an integrated circuit for use in stabilizing an input voltage to a predetermined voltage so as to output the predetermined voltage by controlling a power transistor which is connected in series with a power supply line; and an overcurrent detecting resistor which is connected in series with the power supply line being realized by a resistor externally provided to the integrated circuit.

10. An electronic device including a switching power supply having a stabilized power supply-use device which comprises: an integrated circuit for use in stabilizing an input voltage to a predetermined voltage so as to output the predetermined voltage; and an element for overcurrent detection being provided to be exposed outside of the integrated circuit.

11. An electronic device including a switching power supply having a stabilized power supply-use device which comprises: an integrated circuit for use in stabilizing an input voltage to a predetermined voltage so as to output the predetermined voltage by controlling a power transistor which is connected in series with a power supply line; and an overcurrent detecting resistor which is connected in series with the power supply line being realized by a resistor externally provided to the integrated circuit.
